(19) United States
(12) Patent Application Publication
(10) Pub. No.: US 2013/0144439 A1
(43) Pub. Date: Jun. 6, 2013

(54) WALKING ROBOT AND CONTROL METHOD THEREOF

(71) Applicant: SAMSUNG ELECTRONICS CO., LTD., Suwon-si (KR)

(72) Inventors: Min Hyung LEE, Anyang-si (KR); Jae Ho Park, Suwon-si (KR); Kyung Shik Roh, Seongnam-si (KR); Ju Suk Lee, Hwaseong-si (KR)

(73) Assignee: SAMSUNG ELECTRONICS CO., LTD., Suwon-si (KR)

(21) Appl. No.: 13/693,565

(22) Filed: Dec. 4, 2012

(30) Foreign Application Priority Data
Dec. 6, 2011 (KR) 10-2011-0129645

(51) Int. Cl. B25J 9/16

(52) U.S. Cl. CPC B25J 9/1633
USPC 700/261

(57) ABSTRACT

A walking robot to prevent slippage of a swing foot on the ground and a control method thereof includes generating a target angle trajectory for each joint unit of legs, calculating a torque, which tracks the target angle trajectory, for each joint unit, determining whether slippage of a swing foot connected to a swing leg of the two legs occurs, calculating a final torque to be provided to each joint unit of the swing leg based on a velocity sensed from the swing foot if occurrence of slippage of the swing foot is determined, and providing the calculated final torque to each joint unit. By sensing whether slippage of the swing foot occurs when the swing foot touches the ground and restricting a torque to be applied to each joint unit based on the sensed result, stable walking of the robot is realized.

### CROSS-REFERENCE TO RELATED APPLICATIONS

This application claims the priority benefit of Korean Patent Application No. 10-2011-0129645, filed on Dec. 6, 2011, in the Korean Intellectual Property Office, the disclosure of which is incorporated herein by reference.

### BACKGROUND

1. Field

Embodiments disclosed herein relate to a walking robot, which prevents slippage of a swing foot when the swing foot touches the ground, and a control method thereof.

2. Description of the Related Art

Research and development of walking robots which have a joint system similar to that of humans and which coexist with humans in human working and living spaces is actively progressing. The walking robots are multi-legged walking robots having two legs, or three or more legs. To achieve stable walking of the robot, actuators, such as electric motors or hydraulic motors, located at respective joints of the robot need to be driven. Several methods to drive these actuators are being researched. One method includes a position-based Zero Moment Point (ZMP) control method in which command angles of respective joints, i.e. command positions, are given and the joints are controlled so as to track the command positions. Another method includes a torque-based Finite State Machine (FSM) control method in which command torques of respective joints are given and the joints are controlled so as to track the command torques.

In the ZMP control method, for example, a walking direction, stride and walking velocity of a robot are preset to satisfy a ZMP constraint in that a ZMP is present in a safety region within a support polygon formed by one or more supporting legs. For example, if the robot is supported by one leg, a support polygon may be formed in the region of the leg, and if the robot is supported by two legs, a region may be set to have a small area in consideration of safety within a convex polygon including the region of the two legs. Walking patterns of the respective legs may be generated corresponding to the preset values, and walking trajectories of the respective legs based on the walking patterns may be calculated. Additionally, angles of joints of the respective legs are calculated based on inverse kinematics of the calculated walking trajectories, and in turn target control values of the respective joints are calculated using current angles and target angles of the respective joints. Moreover, servo control allowing the respective legs to track the calculated walking trajectories per control time is carried out. That is, during walking of the robot, whether or not positions of the respective legs accurately track the walking trajectories depending on the walking patterns is detected, and if it is detected that the respective legs deviate from the walking trajectories, torques of the motors are adjusted so that the respective legs accurately track the walking trajectories.

The ZMP control method is a position-based control method enabling accurate position control, but needs to perform accurate angle control of the respective joints in order to control the ZMP, and thus requires high servo gain. This is accompanied by low energy efficiency due to high current, and high joint stiffness, having a serious effect on the surrounding environment. Furthermore, since elimination of kinematic singularity may be necessary to calculate the angles of the respective joints, the robot always walks with bent knees, having an unnatural gait.

On the other hand, instead of tracking positions per control time, in the FSM control method, a finite number of operating states of a robot is predefined, target torques of respective joints are calculated with reference to the respective operating states during walking, and the joints are controlled so as to track the target torques. Controlling the torques of the respective joints during walking may cause high energy efficiency and low joint stiffness owing to low servo gain, providing safety for the surrounding environment. Moreover, it may be unnecessary to eliminate kinematic singularity, which allows the robot to have a natural gait in the same manner as that of a human.

However, in the FSM control method in which walking of the robot is controlled based on the predefined operating states, the robot may have the possibility of losing balance due to inappropriate walking control. Therefore, the robot may perform an additional balancing motion regardless of a walking motion. For the balancing motion of the robot, calculation of command torques required to realize a stable balance may be necessary. This is accompanied by a solution of a very complex dynamic equation, and up to now has not been realized in a robot having legs each of which has a joint structure of 6 degrees of freedom.

### SUMMARY

Therefore, it is an aspect of the present invention to provide a walking robot, which realizes stable walking even if slippage occurs when a swing foot touches the ground, and a control method thereof.

Additional aspects of the invention will be set forth in part in the description which follows and, in part, will be apparent from the description, or may be learned by practice of the invention.

In accordance with an aspect of the present invention, a control method of a walking robot includes generating a target angle trajectory, required for walking of the robot, with respect to each of a plurality of joint units provided at a plurality of legs according to operating states of the plurality of legs, calculating a torque, which tracks the target angle trajectory, with respect to each of the plurality of joint units provided at the plurality of legs, determining whether or not slippage of a swing foot connected to a swing leg among the plurality of legs occurs, calculating a final torque to be provided to each joint unit of the swing leg based on a velocity sensed from the swing foot if it is determined that slippage of the swing foot occurs, and providing the calculated final torque to each joint unit of the swing leg.

The control method may further include providing the calculated torque to each of the plurality of joint units provided at the plurality of legs if no slippage of the swing foot occurs.

Calculation of the torque may include calculating at least one of a torque in a roll-direction, a torque in a pitch-direction and a torque in a yaw-direction with respect to each of the plurality of joint units provided at the plurality of legs.

Determination of whether or not slippage of the swing foot occurs may include comparing a load sensed from the swing foot with a preset reference load, comparing a velocity sensed from the swing foot with a preset reference velocity, and determining a direction in which slippage of the swing foot occurs according to the comparative results.

Determination of the direction in which slippage of the swing foot occurs may include determining that slippage of the swing foot occurs in the pitch-direction if a Z-axis load sensed from the swing foot is less than a Z-axis reference load, an X-axis load sensed from the swing foot is less than an X-axis reference load, and an X-axis velocity sensed from the swing foot is greater than an X-axis reference velocity.

Calculation of the final torque may include calculating a final torque in the pitch-direction to be provided to each joint unit of the swing leg if slippage of the swing foot occurs in the pitch-direction.

The final torque in the pitch-direction to be provided to each joint unit of the swing leg may be obtained by multiplying a ratio of the X-axis reference velocity to the X-axis velocity sensed from the swing foot by the torque in the pitch-direction to be provided to each joint unit of the swing leg.

Determination of the direction in which slippage of the swing foot occurs may include determining that slippage of the swing foot occurs in the roll-direction if a Z-axis load sensed from the swing foot is less than a Z-axis reference load, a Y-axis load sensed from the swing foot is less than a Y-axis reference load, and a Y-axis velocity sensed from the swing foot is greater than a Y-axis reference velocity.

Calculation of the final torque may include calculating a final torque in the roll-direction to be provided to each joint unit of the swing leg if slippage of the swing foot occurs in the roll-direction.

The final torque in the roll-direction to be provided to each joint unit of the swing leg may be obtained by multiplying a ratio of the Y-axis reference velocity to the Y-axis velocity sensed from the swing foot by the torque in the roll-direction to be provided to each joint unit of the swing leg.

In accordance with another aspect of the present invention, a walking robot includes a target angle trajectory generator to generate a target angle trajectory, required for walking of the robot, with respect to each of a plurality of joint units provided at a plurality of legs according to operating states of the plurality of legs, a torque calculator to calculate a torque, which tracks the target angle trajectory, with respect to each of the plurality of joint units provided at the plurality of legs, and a walking state determiner to determine whether or not slippage of a swing foot connected to a swing leg among the plurality of legs occurs. The torque calculator may calculate a final torque to be provided to each joint unit of the swing leg based on a velocity sensed from the swing foot if it is determined that slippage of the swing foot occurs, and a controller may provide the calculated final torque to each joint unit of the swing leg.

The controller may provide the calculated torque to each of the plurality of joint units provided at the plurality of legs if no slippage of the swing foot occurs.

The torque calculator may calculate at least one of a torque in a roll-direction, a torque in a pitch-direction and a torque in a yaw-direction with respect to each of the plurality of joint units provided at the plurality of legs.

The walking state determiner may determine the direction in which slippage of the swing foot occurs by comparing a load sensed from the swing foot with a preset reference load, and comparing a velocity sensed from the swing foot with a preset reference velocity.

The walking state determiner may determine that slippage of the swing foot occurs in the pitch-direction if a Z-axis load sensed from the swing foot is less than a Z-axis reference load, an X-axis load sensed from the swing foot is less than an X-axis reference load, and an X-axis velocity sensed from the swing foot is greater than an X-axis reference velocity.

The torque calculator may calculate a final torque in the pitch-direction to be provided to each joint unit of the swing leg if slippage of the swing foot occurs in the pitch-direction.

The final torque in the pitch-direction to be provided to each joint unit of the swing leg may be obtained by multiplying a ratio of the X-axis reference velocity to the X-axis velocity sensed from the swing foot by the torque in the pitch-direction to be provided to each joint unit of the swing leg.

The walking state determiner may determine that slippage of the swing foot occurs in the roll-direction if a Z-axis load sensed from the swing foot is less than a Z-axis reference load, a Y-axis load sensed from the swing foot is less than a Y-axis reference load, and a Y-axis velocity sensed from the swing foot is greater than a Y-axis reference velocity.

The torque calculator may calculate a final torque in the roll-direction to be provided to each joint unit of the swing leg if slippage of the swing foot occurs in the roll-direction.

The final torque in the roll-direction to be provided to each joint unit of the swing leg may be obtained by multiplying a ratio of the Y-axis reference velocity to the Y-axis velocity sensed from the swing foot by the torque in the roll-direction to be provided to each joint unit of the swing leg.

The walking robot may include a memory which stores the preset reference load and preset reference velocity values.

In accordance with another aspect of the present invention, a control method of a walking robot may include generating a target angle trajectory for a first joint unit provided at a swing leg of the robot among a plurality of legs of the robot, according an operating state indicating a pose of the swing leg, calculating a first torque, which tracks the target angle trajectory, for the first joint unit, determining whether slippage of a swing foot connected to the swing leg occurs, and calculating and applying a second torque to the first joint unit of the swing leg based on a velocity sensed from the swing foot if it is determined slippage of the swing foot occurs. The second torque may be less than the first torque.

Whether slippage of the swing foot occurs may be determined by sensing a velocity of the swing foot using a velocity sensor disposed on the swing foot, and sensing a load of the swing foot using a force sensor disposed on the swing foot.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view showing an external appearance of a walking robot according to an embodiment of the present invention;

FIG. 2 is a view showing main joint structures of the walking robot shown in FIG. 1;

FIG. 3 is a control block diagram of a walking robot according to an embodiment of the present invention;

FIG. 4 is a view showing measurement of a rotating angle of a hip joint unit;

FIG. 5 is a view showing measurement of a rotating angle of a knee joint unit;

FIG. 6 is a view showing measurement of a rotating angle of an ankle joint unit;

FIG. 7 is a view showing operating states of the walking robot and control actions for the respective operating states in the case of FSM based walking;

FIG. 8 is an explanatory view of a walking robot control concept according to an embodiment of the present invention; and

FIG. 9 is a flowchart showing a control method of a walking robot according to the embodiment of the present invention.

### DETAILED DESCRIPTION

The advantages and features and the way of attaining them will become apparent with reference to embodiments described below in detail in conjunction with the accompanying drawings. Embodiments, however, may be embodied in many different forms and should not be constructed as being limited to exemplary embodiments set forth herein. Rather, these embodiments are provided so that this disclosure will be through and complete and will fully convey the scope of the invention to those skilled in the art. The scope of the present invention should be defined by the claims.

Reference will now be made in detail to a walking robot and a control method thereof according to the embodiments of the present invention, examples of which are illustrated in the accompanying drawings, wherein like reference numerals refer to like elements throughout.

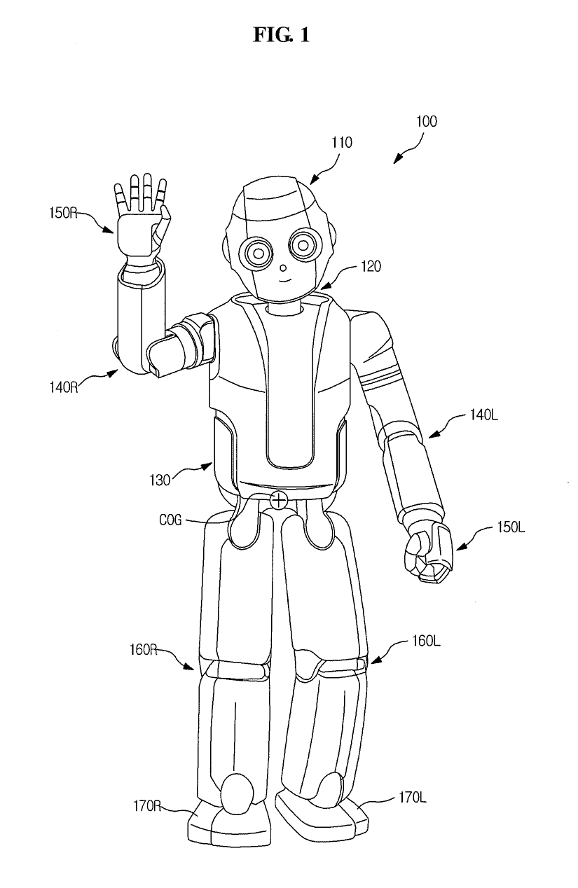

FIG. 1 is a perspective view showing an external appearance of a walking robot according to an embodiment of the present invention.

As shown in FIG. 1, the walking robot 100 may include an upper body and a lower body. The upper body may include a head 110, a neck 120, a torso 130, arms 140R and 140L, and hands 150R and 150L. The lower body may include a plurality of legs 160R and 160L and feet 170R and 170L.

The upper body of the walking robot 100 may include the head 110, the torso 130 connected to the bottom of the head 110 via the neck 120, the two arms 140R and 140L connected to both sides of an upper portion of the torso 130, and the hands 150R and 150L connected respectively to distal ends of the two arms 140R and 140L.

The lower body of the walking robot 100 may include the two legs 160R and 160L connected to both sides of a lower portion of the torso 130 of the upper body, and the feet 170R and 170L connected respectively to distal ends of the two legs 160R and 160L.

Here, the head 110, two arms 140R and 140L, two hands 150R and 150L, two legs 160R and 160L, and two feet 170R and 170L each have predetermined degrees of freedom via joints.

In FIG. 1, “R” refers to the right side of the walking robot 100, “L” refers to the left side of the walking robot 100, and “COG” indicates the center of gravity of the walking robot 100.

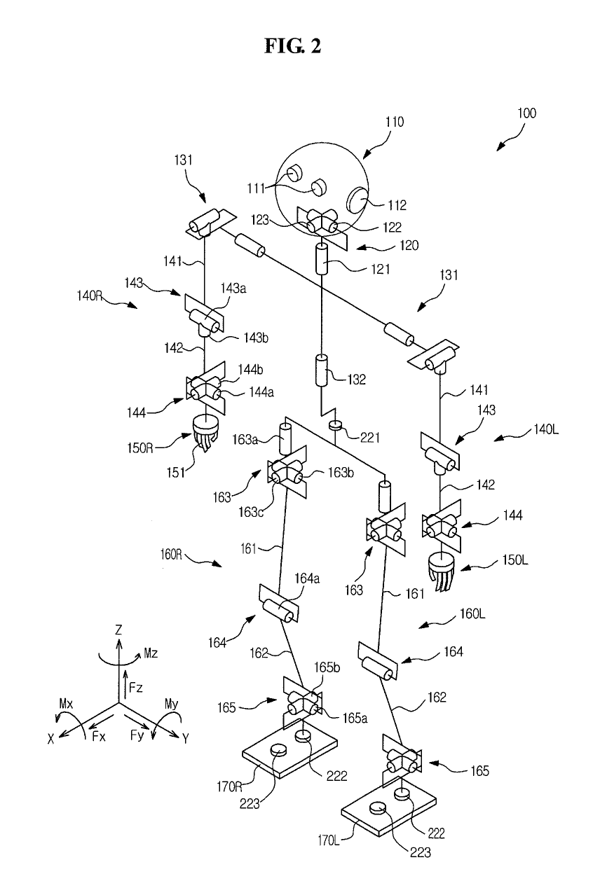

FIG. 2 is a view showing main joint structures of the walking robot shown in FIG. 1.

Cameras 111 to capture surrounding images and microphones 112 to detect user's voice are installed to the head 110. The head 110 is connected to the torso 130 via the neck 120.

The neck 120 contains a plurality of rotary joints 121, 122 and 123. More specifically, a neck joint unit may include the rotary joint 121 in the yaw-direction (rotated around the z-axis), rotary joint 122 in the pitch-direction (rotated around the y-axis), and rotary joint 123 in the roll-direction (rotated around the x-axis), and has 3 degrees of freedom. Here, the rotary joints 121, 122 and 123 of the neck joint unit are respectively connected to motors (not shown) for rotation of the head 110.

Shoulder joint units 131 are respectively provided at both sides of the torso 130 to connect the two arms 140R and 140L to the torso 130. A rotary joint unit 132 in the yaw-direction is provided between the chest and the waist to enable rotation of the chest relative to the waist.

An inclination sensor 221 is installed to the torso 130. The inclination sensor may include a pose sensor. The inclination sensor 221 generates pose data by detecting tilt angles, for example, inclinations of the upper body and of the two legs 160R and 160L with respect to a vertical axis, and angular velocities of the same. The inclination sensor 221 may be installed to the two legs 160R and 160L in addition to the torso 130.

The two arms 140R and 140L of the walking robot 100 respectively include upper arm links 141, lower arm links 142, elbow joint units 143, and wrist joint units 144.

Each of the upper arm links 141 is connected to the torso 130 via the shoulder joint unit 131, and is connected to the lower arm link 142 via the elbow joint unit 143. Each of the lower arm links 142 is connected to the hand 150R or 150L via the wrist joint unit 144.

The elbow joint unit 143 may include a rotary joint 143a in the pitch-direction and a rotary joint 143b in the yaw-direction, and has 2 degrees of freedom.

The wrist joint unit 144 may include a rotary joint 144a in the pitch-direction and a rotary joint 144b in the roll-direction, and has 2 degrees of freedom.

The respective hands 150R and 150L may contain five fingers 151. Each finger 151 may contain multiple joints (not shown) that are driven by motors. The fingers 151 execute various motions, such as gripping an object or pointing in a specific direction, in linkage with movements of the arms 140R and 140L. Hands 150R and 150L may contain more or less than five fingers. The number of fingers may depend on the functions required of the robot for a particular application and/or the characteristics of the objects to be handled.

The two legs 160R and 160L of the walking robot 100 respectively include thigh links 161, calf links 162, hip joint units 163, knee joint units 164, ankle joint units 165, and the two feet 170R and 170L.

The thigh links 161 are connected to the torso 130 via the hip joint units 163, and are connected to the calf links 162 via the knee joint units 164.

The calf links 162 are connected to the feet 170R and 170L via the ankle joint units 165.

Each of the hip joint units 163 may include a rotary joint (hip yaw joint) 163a in the yaw-direction (rotated around the z-axis), a rotary joint (hip pitch joint) 163b in the pitch-direction (rotated around the y-axis), and a rotary joint (hip roll joint) 163c in the roll-direction (rotated around the x-axis), and has 3 degrees of freedom.

Each of the knee joint units 164 includes a rotary joint 164a in the pitch-direction, and has 1 degree of freedom.

Each of the ankle joint units 165 includes a rotary joint 165a in the pitch-direction and a rotary joint 165b in the roll-direction, and has 2 degrees of freedom.

Since six rotary joints of the hip joint unit 160, knee joint unit 164 and ankle joint unit 165 are provided on each of the two legs 160L and 160R, a total of twelve rotary joints are provided to the two legs 160L and 160R.

Meanwhile, multi-axis force and torque (F/T) sensors 222 are installed between the feet 170L and 170R and the ankle joint units 165. The F/T sensors 222 detect whether or not the feet 170L and 170R touch the ground and load applied to the feet 170L and 170R by measuring three-directional components Fx, Fy and Fz of force and three-directional components Mx, My and Mz of moment transmitted from the feet 170L and 170R. Velocity sensors 223 that sense velocities of the two feet 170L and 170R of the robot 100 may be provided on each respective foot, 170L and 170R of the robot.

Although not shown in the drawings, actuators, such as motors, are installed to respective joints of the walking robot 100. Thus, the respective joints may realize various motions via implementation of appropriate rotation by the motors.

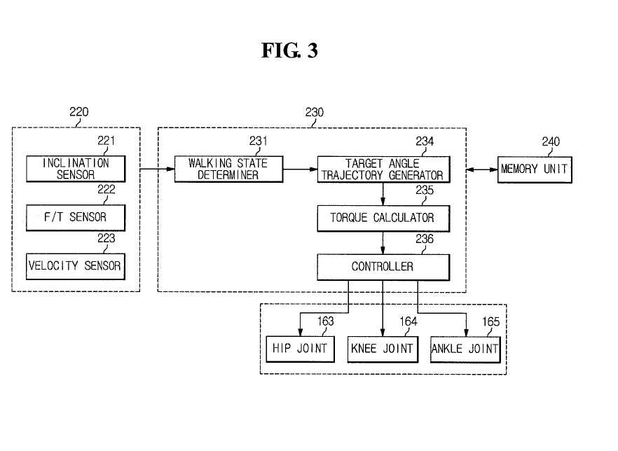

A walking control unit (see reference numeral “230” in FIG. 3) to control general operations of the walking robot 100 allows the robot 100 to perform stable and natural walking while maintaining balance. This will be described in more detail with reference to FIG. 3.

FIG. 3 is a control block diagram of the walking robot according to an embodiment of the present invention. As shown in FIG. 3, the walking robot 100 may include a sensing unit 220, the walking control unit 230, and a memory unit 240.

The sensing unit 220 senses change in walking of the robot and provides the sensed result to the walking control unit 230. More specifically, the sensing unit 220 may include the inclination sensor 221 that senses an inclination of the upper body of the robot 100, multi-axis F/T sensor 222 that senses load applied to the two feet 170L and 170R of the robot 100, and a velocity sensor 223 that senses velocities of the two feet 170L and 170R of the robot 100. The sensing unit 220 may also include one or more cameras, sonar, infrared, RFID, or lasers for visual sensing, and may take video or images of objects for image processing. The sensing unit 220 may also include audio sensors. The sensing unit may also include encoders, accelerometers, gyroscopes, and the like to measure changes in the robot.

The inclination sensor 221 is installed to the torso 130. The inclination sensor 221 senses an inclination of the upper body with respect to a vertical axis, for example, rotating angles in pitch, roll, and yaw directions and rotating velocities. The inclination sensor 221 may include an Inertial Measurement Unit (IMU).

The multi-axis F/T sensor 222 is provided between the respective legs 160R and 160L and the feet 170R and 170L and senses a load applied to the feet 170R and 170L. The F/T sensor 222 senses three-directional components Fx, Fy and Fz of force and three-directional components Mx, My and Mz of moment transmitted from the feet 170L and 170R and provides the sensed results to the walking control unit 230.

The velocity sensor 223 senses velocities of the two feet 170L and 170R and provides the sensed results to the walking control unit 230.

The above-described sensing unit 220 may sense rotating angles of the hip joint unit 163, knee joint unit 164 and ankle joint unit 165. Here, the rotating angles of the respective joint units 163, 164 and 165 may be calculated using revolutions per minute of the motors (not shown) provided at the respective joints. The revolutions per minute of the respective motors (not shown) are detectable via encoders (not shown) connected to the respective motors.

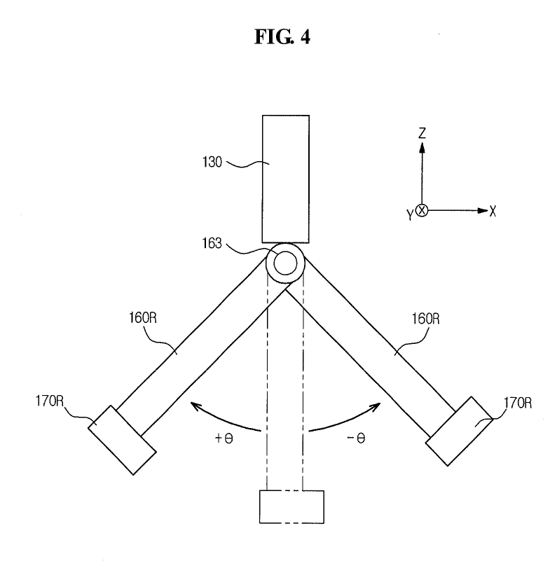

Methods to measure the rotating angles of the respective joint units 163, 164 and 165 are shown in FIGS. 4 to 6. FIGS. 4, 5 and 6 are respective explanatory views of methods to measure the rotating angles of the hip joint unit 163, knee joint unit 164 and ankle joint unit 165. The drawings are shown as viewed from the right side.

Referring to FIG. 4, it will be appreciated that a rotating angle measured when the hip joint unit 163 is rotated in the pitch-direction on the basis of a vertical axis (i.e., when the right leg 160R is pivoted rearward) is +θ, and a rotating angle when the hip joint unit 163 is rotated in an opposite direction (i.e. when the right leg 160R is pivoted forward) is −θ.

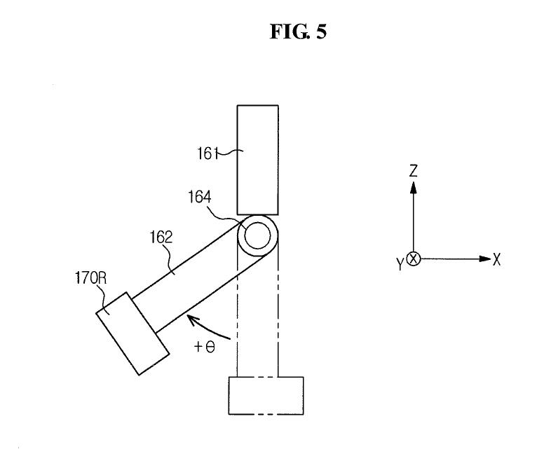

Referring to FIG. 5, it will be appreciated that the knee joint unit 164 is rotatable only in the pitch-direction on the basis of a vertical axis (i.e., when the right leg 160R is pivoted rearward) and in this case, a measured rotating angle is +θ.

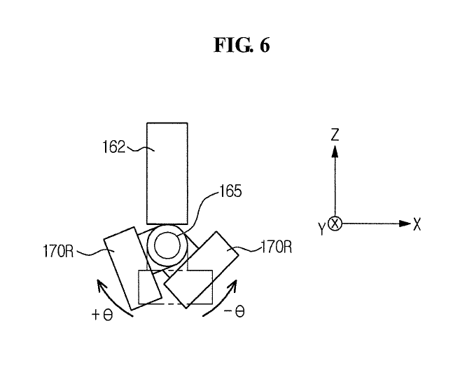

Referring to FIG. 6, it will be appreciated that a rotating angle measured when the ankle joint unit 165 is rotated in the pitch-direction on the basis of a vertical axis (e.g., when the right foot 170R is pivoted rearward) is +θ, and a rotating angle when the ankle joint unit 165 is rotated in an opposite direction (e.g., when the right foot 170R is pivoted forward) is −θ.

Referring again to FIG. 3, the walking control unit 230 controls general walking states of the robot 100 based on the sensed results provided by the sensing unit 220. To this end, the walking control unit 230 may include a walking state determiner 231, a target angle trajectory generator 234, a torque calculator 235, and a controller 236.

The walking state determiner 231 determines whether or not the foot 170R or 170L of the robot 100 touches the ground based on load applied to the foot 170R or 170L. Additionally, the walking state determiner 231 determines the leg connected to the foot, the load of which is sensed, as a stance leg that supports the ground, and determines the leg connected to the foot, the load of which is not sensed, as a swing leg that bends to be lifted from the ground beyond a predetermined height. More specifically, if the F/T sensor 222 of the sensing unit 220 senses the load from the right foot 170R of the robot 100, the walking state determiner 231 determines that the right foot 170R touches the ground. Thus, the walking state determiner 231 determines the right leg 160R connected to the right foot 170R as the stance leg, and determines the left leg 160L as the swing leg. If the F/T sensor 222 of the sensing unit 220 senses the load from the left foot 170L of the robot 100, the walking control unit 230 determines that the left foot 170L touches the ground. Thus, the walking control unit 230 determines the left leg 160L connected to the left foot 170L as the stance leg, and determines the right leg 160R as the swing leg.

The walking state determiner 231 controls walking of the robot 100 based on operating states of the two legs in a Finite State Machine (FSM) control manner. Hereinafter, operating states of the two legs 160L and 160R will be described in more detail.

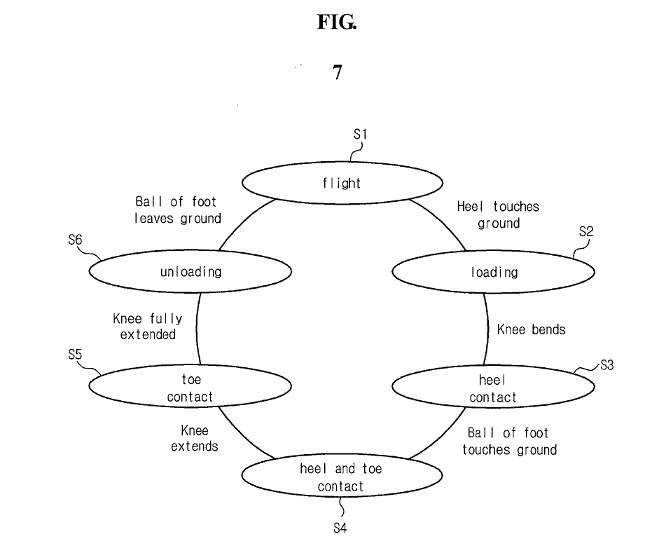

FIG. 7 is a view showing operating states of the robot and control actions for the respective operating states in the case of FSM based walking.

Referring to FIG. 7, in the torque-based FSM control method, the robot 100 has a plurality of predefined operating states (for example, six states S1, S2, S3, S4, S5 and S6). The respective operating states S1, S2, S3, S4, S5 and S6 indicate poses of one leg 160L or 160R of the robot 100 during walking. Appropriate transition between the poses of the robot 100 ensures stable walking of the robot 100.

A single walking motion may be organized, for example, by the operating states S1, S2, S3, S4, S5 and S6 and via transition between the operating states.

The first operating state (flight state) S1 corresponds to a pose of swinging the leg 160L or 160R, the second operating state (loading state) S2 corresponds to a pose of loading the foot 170L or 170R on the ground, the third operating state (heel contact state) S3 corresponds to a pose of bringing the heel of the foot 170L or 170R into contact with the ground, the fourth operating state (heel and toe contact state) S4 corresponds to a pose of bringing both the heel and the toe of the foot 170L or 170R into contact with the ground, the fifth operating state (toe contact state) S5 corresponds to a pose of bringing the toe of the foot 170L or 170R into contact with the ground, and the sixth operating state (unloading state) S6 corresponds to a pose of unloading the foot 170R or 170K from the ground.

In order to transition from one operating state to another operating state, a control action to achieve such transition is required.

In the case of transition from the first operating state S1 to the second operating state S2 (S1→S2), a control action in which the heel of the foot 170L or 170R touches the ground is required.

In the case of transition from the second operating state S2 to the third operating state S3 (S2→S3), a control action in which the knee (more particularly, the knee joint unit) connected to the foot 170L or 170R touching the ground bends is required.

In the case of transition from the third operating state S3 to the fourth operating state S4 (S3→S4), a control action in which the ball of the foot 170L or 170R touches the ground is required.

In the case of transition from the fourth operating state S4 to the fifth operating state S5 (S4→S5), a control action in which the knee joint unit 164 connected to the foot 170L or 170R touching the ground extends is required.

In the case of transition from the fifth operating state S5 to the sixth operating state S6 (S5→S6), a control action in which the knee joint unit 164 connected to the foot 170L or 170R touching the ground fully extends is required.

In the case of transition from the sixth operating state S6 to the first operating state S1 (S6→S1), a control action in which the ball of the foot 170L or 170R leaves the ground is required.

In this way, to execute these control actions, the robot 100 calculates torques of the respective joints based on a corresponding control action, and outputs the calculated torques to the actuators, such as the motors, installed to the respective joints, to drive the actuators.

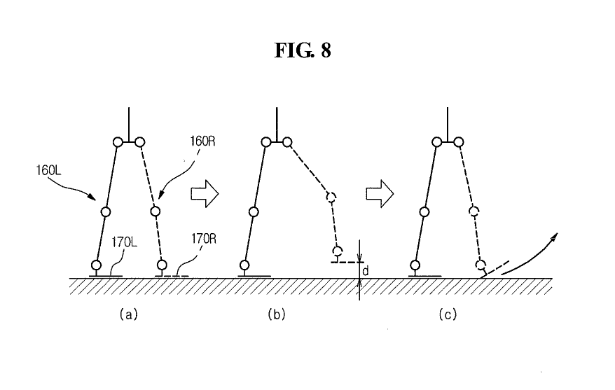

Referring again to FIG. 3, when the foot connected to the swing leg (hereinafter referred to as the ‘swing foot’) touches the ground, the walking state determiner 231 may determine whether or not slippage of the swing foot occurs. In this case, the walking state determiner 231 determines whether or not slippage occurs based on a load and velocity sensed from the swing foot. Now, the principle of determining whether or not slippage of the swing foot occurs will be described in brief with reference to FIG. 8.

FIG. 8 is a view showing a walking procedure of the robot. During walking, the robot 100 moves in the order of (a), (b) and (c) of FIG. 8. FIG. 8(a) shows a state in which the two legs 160R and 160L of the robot 100 support the ground. FIG. 8(b) shows a state in which the left leg 160L of the robot 100 supports the ground and the right leg 160R bends such that the right foot 170R is lifted from the ground beyond a predetermined height d, i.e. beyond a ground clearance. FIG. 8(c) shows a state in which the bent right leg 160R of the robot 100 extends such that the heel of the right foot 170R touches the ground.

For example, assuming that the weight of the robot 100 is 50 kg, a load of approximately 500 newtons (500N) approximately the weight of 50 kg×the gravity acceleration of 9.8 m/s²) is applied to the robot 100. Thus, as shown in FIG. 8(a), when the two legs 160R and 160L of the robot 100 support the ground, a load of 250N is applied to each of the left leg 160L and the right leg 160R. Thereafter, as shown in FIG. 8(b), when only the left leg 160L of the robot 100 supports the ground, a load of 500N is applied to only the left leg 160L. As shown in FIG. 8(c), when the heel of the right foot 170R slightly touches the ground while the left leg 160L supports the ground, a load applied to the left leg 160L gradually decreases from 500N and a load applied to the right foot 170R gradually increases. If slippage of the right foot 170R occurs while the heel of the right foot 170R slightly touches the ground, a velocity of the right foot 170R suddenly increases.

In this way, when the swing foot slightly touches the ground, whether or not slippage of the swing foot occurs may be determined based on a load and velocity sensed from the swing foot. In this case, the load sensed from the swing foot includes an X-axis load, Y-axis load and Z-axis load. Also, the velocity sensed from the swing foot includes an X-axis velocity, Y-axis velocity and Z-axis velocity. Thus, whether or not slippage of the swing foot occurs may be determined via an appropriate combination of load conditions and velocity conditions with respect to the respective axes of the swing foot. Equation 1 and Equation 2, shown below, express conditions to determine an occurrence of slippage of the swing foot.

(FT_{z}<F_{z}) and (FTₓ<Fₓ) and (Velₓ>Vₓ) [Equation 1]

(FT_{z}<F_{z}) and (FT_{y}<F_{y}) and (Vel_{y}>V_{y}) [Equation 2]

In Equation 1 and Equation 2, ‘FT’ indicates load sensed by the F/T sensor 222. More specifically, ‘FTₓ’ indicates the X-axis load among the loads sensed by the F/T sensor 222, ‘FT_{y}’ indicates the Y-axis load among the loads sensed by the F/T sensor 222, and ‘FT_{z}’ indicates the Z-axis load among the loads sensed by the F/T sensor 222.

In Equation 1 and Equation 2, ‘F’ indicates a predefined reference load. More specifically, ‘Fₓ’ indicates a reference load that is set with respect to the X-axis load (hereinafter referred to as ‘X-axis reference load’), ‘F_{y}’ indicates a reference load that is set with respect to the Y-axis load (hereinafter referred to as ‘Y-axis reference load’), and ‘F_{z}’ indicates a reference load that is set with respect to the Z-axis load (hereinafter referred to as ‘Z-axis reference load’).

In Equation 1 and Equation 2, ‘Vel’ indicates the velocity of the swing foot sensed by the velocity sensor 223. More specifically, ‘Velₓ’ indicates the X-axis velocity of the swing foot (hereinafter referred to as ‘X-axis sensed velocity’), and ‘Vel_{y}’ indicates the Y-axis velocity of the swing foot (hereinafter referred to as ‘Y-axis sensed velocity’).

Also, ‘V’ indicates a predefined reference load. More specifically, ‘Vₓ’ indicates a predefined reference velocity with respect to the X-axis velocity (hereinafter referred to as ‘X-axis reference velocity’), and ‘V_{y}’ indicates a predefined reference velocity with respect to the Y-axis velocity (hereinafter referred to as ‘Y-axis reference velocity’).

Equation 1 expresses conditions to determine whether or not slippage of the swing foot occurs along the X-axis. Referring to Equation 1, the robot 100 may determine that slippage of the swing foot occurs along the X-axis if the Z-axis load FT_{z} sensed from the swing foot is less than the Z-axis reference load F_{z}, the X-axis load FTₓ sensed from the swing foot is less than the X-axis reference load Fₓ, and the X-axis velocity Velₓ sensed from the swing foot is greater than the X-axis reference velocity Vₓ. That is, if all three conditions in Equation 1 are satisfied, then the robot 100 may determine that slippage of the swing foot occurs along the X-axis. However, the disclosure is not so limited. For example, if two of the three conditions in Equation 1 are satisfied, including the velocity condition, then the robot 100 may determine that slippage of the swing foot occurs along the X-axis.

Meanwhile, it may be determined based on in Equation 1 whether or not the Z-axis load FT_{z} sensed from the swing foot is less than the Z-axis reference load F_{z}, in order to determine how much the swing foot touches the ground. If the Z-axis reference load F_{z} is set to 50N, this indicates that whether or not slippage occurs is determined when the swing foot slightly touches the ground. If the Z-axis reference load F_{z} is set to 100N, this indicates that whether or not slippage occurs is determined when the swing foot touches the ground by an increased area. This concept is equally applied in the case of determining whether or not the X-axis load FTₓ sensed from the swing foot is less than the X-axis reference load F.

Equation 2 expresses conditions to determine whether or not slippage of the swing foot occurs along the Y-axis. Referring to Equation 2, the robot 100 may determine that slippage of the swing foot occurs along the Y-axis if the Z-axis load FT_{z} sensed from the swing foot is less than the Z-axis reference load F_{z}, the Y-axis load FT_{y} sensed from the swing foot is less than the Y-axis reference load F_{y}, and the Y-axis velocity Vel_{y} sensed from the swing foot is greater than the Y-axis reference velocity V_{y}. That is, if all three conditions in Equation 2 are satisfied, then the robot 100 may determine that slippage of the swing foot occurs along the Y-axis. However, the disclosure is not so limited. For example, if two of the three conditions in Equation 2 are satisfied, including the velocity condition, then the robot 100 may determine that slippage of the swing foot occurs along the Y-axis.

Referring again to FIG. 3, the walking state determiner 231, as described above, compares loads of the respective axes sensed from the swing foot with reference loads for the respective axes, and compares velocities of the respective axes sensed from the swing foot with reference velocities for the respective axes, thereby determining whether or not slippage of the swing foot occurs and the direction in which slippage of the swing foot occurs based on the comparative results.

The target angle trajectory generator 234 generates a target angle trajectory for the respective joint units 163, 164 and 165 of the two legs 160R and 160L based on operating states of the respective legs determined by the walking state determiner 231. The target angle trajectory may be generated by extracting knot points from data related to change in the angles of the respective joint units 163, 164 and 165 over time, and smoothly connecting the extracted knot points along a spline. Here, the knot points refer to angle commands of the respective joint units 163, 164 and 165 for implementation of the operating states, and correspond to the respective operating states. The target angle trajectory generated by the target angle trajectory generator 234 is provided to the torque calculator 235.

The torque calculator 235 calculates torques that track the target angle trajectories of the respective joint units 163, 164 and 165 of the two legs 160R and 160L. Calculation of the torques for the respective joint units 163, 164 and 165 is performed per control period. A control period may refer to the time to process or execute one or more commands. For example the control period may refer to the time for a torque control signal corresponding to the calculated torque to be transmitted, for example, to a joint unit so as to drive an actuator included in the joint unit. Also, the torques may be calculated using a Proportional Derivative (PD) controller. The following Equation 3 is given to calculate the torques of the respective joint units 163, 164 and 165 in a proportional derivative control method.

τ=kₚ·(θ_{d}−θ_{c})+k_{d}·(ω_{d}−ω_{c}) [Equation 3]

In Equation 3, ‘τ’ indicates a torque value per control period, ‘θ_{d}’ indicates a target angle per control period, and ‘θ_{d}’ indicates a current angle (i.e., a current sensed angle) per control period. Also, ‘ω_{d}’ indicates a target angular velocity per control period, and may be obtained by taking the derivative of the target angle θ_{d}. ‘ω_{c}’ indicates a current angular velocity (i.e. a current sensed angular velocity) per control period, and may be obtained by taking the derivative of the current angle θ_{c}. ‘Kₚ’ and ‘K_{d}’ indicate coefficients, which may be experimentally determined to achieve stable walking of the robot.

As described above, the torque calculator 235 calculates the torques that track the target angle trajectories based on Equation 3. The above-described Equation 3 expresses a common method to calculate torques for respective joint units of legs. Thus, when calculating the torques for the respective joint units 163, 164 and 165, the torque calculator 235 calculates torques in roll, pitch, and yaw directions with reference to Equation 3. The torques in roll, pitch, and yaw directions may be represented by ‘τᵣₒₗₗ’, ‘τ_{pitch}’, and ‘τ_{yaw}’.

The torque calculator 235 restricts the torques to be provided to the respective joint units of the swing leg based on the result of determining whether or not slippage of the swing foot occurs by the walking state determiner 231. More specifically, when the walking state determiner 231 determines that slippage of the swing foot occurs, the torque calculator 235 calculates final torques to be provided to the respective joint units of the swing leg in a direction in which slippage of the swing foot occurs. If it is determined that slippage of the swing foot occurs along the X-axis, the torque calculator 235 calculates final torques in the pitch-direction to be provided to the respective joint units of the swing leg. If it is determined that slippage of the swing foot occurs along the Y-axis, the torque calculator 235 calculates final torques in the roll-direction to be provided to the respective joint units of the swing leg. The following Equation 4 is given to calculate the final torques in the pitch-direction to be provided to the respective joint units. Also, the following Equation 5 is given to calculate the final torques in the roll-direction to be provided to the respective joint units.

$$\begin{matrix}{Final\_τ}_{pitch} = {τ}_{pitch} \times \frac{{V}_{x}}{{Vel}_{x}} & [ Equation 4 ] \\ {Final\_τ}_{roll} = {τ}_{roll} \times \frac{{V}_{y}}{{Vel}_{y}} & [ Equation 5 ]\end{matrix}$$

In Equation 4, ‘Final_τ_{pitch}’ indicates the final torque in the pitch-direction of the joint unit, and ‘τ_{pitch}’ indicates the torque in the pitch-direction of the joint unit. The torque in the pitch-direction is calculated based on Equation 3. Referring to Equation 4, the final torque in the pitch-direction of the joint unit Final_τ_{pitch} is calculated by multiplying a ratio of the X-axis reference velocity Vₓ of the swing foot to the sensed X-axis velocity Velₓ by the torque in the pitch-direction of the corresponding joint unit τ_{pitch}. As will be appreciated from Equation 4, the greater the sensed X-axis velocity Velₓ of the joint unit than the X-axis reference velocity Vₓ, the smaller the final torque in the pitch-direction to be provided to the corresponding joint unit. That is, the value of the X-axis velocity Velₓ and the final torque value in the pitch-direction have an inversely proportional relationship.

In Equation 5, ‘Final_τᵣₒₗₗ’ indicates the final torque in the roll-direction of the joint unit, and ‘τᵣₒₗₗ’ indicates the torque in the roll-direction of the joint unit. The torque in the roll-direction is calculated based on Equation 3. The final torque in the roll-direction is calculated based on Equation 5. Referring to Equation 5, the final torque in the roll-direction of the joint unit Final_Δᵣₒₗₗ is calculated by multiplying a ratio of the Y-axis reference velocity V_{y} of the swing foot to the sensed Y-axis velocity Vel_{y} by the torque in the roll-direction of the corresponding joint unit τᵣₒₗₗ. As will be appreciated from Equation 5, the greater the sensed Y-axis velocity Vel_{y} of the joint unit than the Y-axis reference velocity V_{y}, the smaller the final torque in the pitch-direction to be provided to the corresponding joint unit. That is, the value of the Y-axis velocity Vel_{y} and the final torque value in the roll-direction have an inversely proportional relationship

The controller 236 provides the torques calculated by the torque calculator 235 to the hip joint units 163, knee joint units 164 and ankle joint units 165 of the two legs 160R and 160L. If occurrence of slippage of the swing foot is determined and the final torques for the respective joint units of the swing leg are calculated by the torque calculator 235, the controller 236 provides the final torques calculated by the torque calculator 235 to the hip joint unit 163, knee joint unit 164 and ankle joint unit 165 of the swing leg.

As the hip joint unit 163, knee joint unit 164 and ankle joint unit 165 receive the torques or final torques provided by the controller 236, actuators, such as motors, installed to the respective joint units are driven. This results in non-slip natural walking of the robot 100.

Meanwhile, the memory unit 240 may store data or algorithms required to control walking of the robot 100. For example, the memory unit 240 may store data sensed by the sensing unit 220, data required to determine whether or not slippage of the swing foot occurs, such as reference loads and reference velocities for the respective axes, and data or algorithms required to calculate the final torques to be provided to the respective joint units of the swing leg.

The memory unit 240 may be embodied into a non-volatile memory device, such as a Read Only Memory (ROM), Random Access Memory (RAM), Programmable Read Only Memory (PROM), Erasable Programmable Read Only Memory (EPROM), and flash memory, a volatile memory device, or a storage medium, such as a hard disk and an optical disc. However, the memory unit 240 is not limited to the above mentioned examples, and may be embodied into other arbitrary forms known in the art.

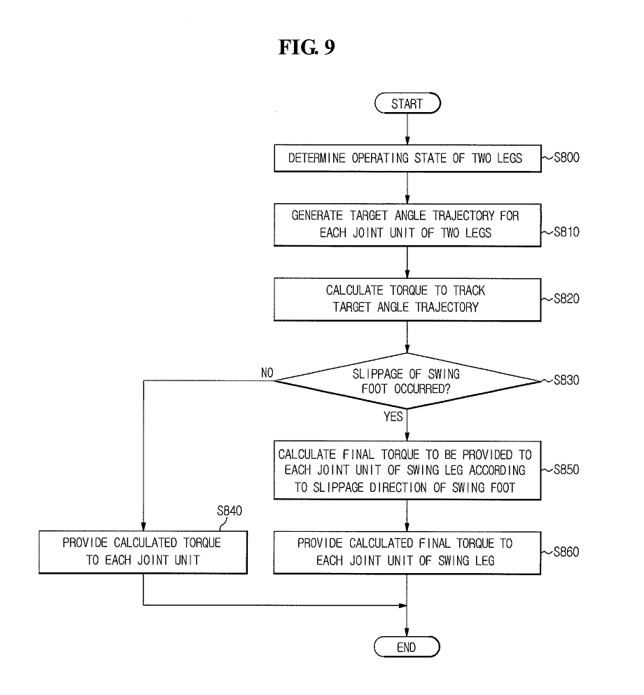

FIG. 9 is a flowchart showing a control method of a walking robot according to the embodiment of the present invention.

If walking begins, the robot 100 determines operating states of the two legs based on loads applied to the two legs (S800). The leg, from which the load is sensed, is determined as the stance leg, and the leg, from which no load is sensed, is determined as the swing leg. Determining the operating states of the two legs may be performed by the walking state determiner 231 of the walking control unit 230.

Next, the robot 100 generates target angle trajectories for the respective joint units of the two legs 160R and 160L based on the determined results of operation S800 (S810). Generating the target angle trajectories for the respective joint units of the two legs 160R and 160L may be performed by the target angle trajectory generator 234 of the walking control unit 230.

Thereafter, the robot 100 calculates torques that track the target angle trajectories for the respective joint units of the two legs 160R and 160L (S820). The torques are calculated using Equation 3. In this case, Equation 3 expresses a common method to calculate torques to be provided to the respective joint units of the two legs 160R and 160L. When actually calculating the torques to be provided to the respective joint units, at least one of the torque in the roll-direction τᵣₒₗₗ, the torque in the pitch-direction τ_{pitch}, and the torque in the yaw-direction τ_{yaw} may be calculated with respect to one joint unit. Calculation of the torques may be performed by the torque calculator 235 of the walking control unit 230.

Subsequently, the robot 100 determines whether or not slippage of the swing foot occurs when the swing foot connected to the swing leg touches the ground (S830). To this end, a load sensed from the swing foot is compared with a preset reference load, and a velocity sensed from the swing foot is compared with a preset reference velocity. Whether or not slippage of the swing foot occurs and a slippage direction of the swing foot, are determined based on the comparative results.

When the load sensed from the swing foot is compared with the preset reference load, an X-axis load sensed from the swing foot is compared with an X-axis reference load and a Y-axis load sensed from the swing foot is compared with a Y-axis reference load. Also, a Z-axis load sensed from the swing foot is compared with a Z-axis reference load.

When the velocity sensed from the swing foot is compared with the preset reference velocity, an X-axis velocity sensed from the swing foot is compared with an X-axis reference velocity and a Y-axis velocity sensed from the swing foot is compared with a Y-axis reference velocity.

If the comparative results fulfill Equation 1 or Equation 2, it is determined that slippage of the swing foot occurs. If the comparative results fulfill Equation 1, it is determined that slippage of the swing foot occurs along the X-axis when the swing foot touches the ground. If the comparative results fulfill Equation 2, it is determined that slippage of the swing foot occurs along the Y-axis when the swing foot touches the ground. Determining whether or not slippage of the swing foot occurs may be performed by the walking state determiner 231 of the walking control unit 230.

If the determined result in operation S830 indicates that no slippage of the swing foot occurs, the robot 100 provides the torques calculated in operation S820 to the respective joint units of the two legs 160R and 160L (S840).

If the determined result in operation S830 indicates that slippage of the swing foot occurs, the robot 100 calculates final torques to be provided to the respective joint units of the swing leg (S850).

If slippage of the swing foot occurs along the X-axis, the final torques in the pitch-direction of the respective joint units are calculated. The final torques in the pitch-direction are calculated using Equation 4. More specifically, among the torques calculated in operation S820, the torque in the pitch-direction τ_{pitch} is multiplied by a ratio of the X-axis reference velocity Vₓ of the swing foot to the sensed X-axis velocity Velₓ. As will be appreciated from Equation 4, the final torque in the pitch-direction is inversely proportional to the sensed X-axis velocity of the swing foot. This means that when the swing foot quickly slips along the X-axis, the torques in the pitch-direction to be provided to the respective joint units of the swing leg are restricted to a greater extent. Also, this means that when the swing foot slowly slips along the X-axis, the torques in the pitch-direction to be provided to the respective joint units of the swing leg are restricted to a smaller extent.

If slippage of the swing foot occurs along the Y-axis, the final torques in the roll-direction of the respective joint units are calculated. The final torques in the roll-direction are calculated using Equation 5. More specifically, among the torques calculated in operation S820, the torque in the roll-direction τᵣₒₗₗ is multiplied by a ratio of the Y-axis reference velocity V_{y} of the swing foot to the sensed Y-axis velocity Vel_{y}. As will be appreciated from Equation 5, the final torque in the roll-direction is inversely proportional to the sensed Y-axis velocity of the swing foot. This means that when the swing foot quickly slips along the Y-axis, the torques in the roll-direction to be provided to the respective joint units of the swing leg are restricted to a greater extent. Also, this means that when the swing foot slowly slips along the Y-axis, the torques in the roll-direction to be provided to the respective joint units of the swing leg are restricted to a smaller extent.

The calculated final torques are provided to the respective joint units of the swing leg (S860) to drive the actuators, such as the motors, installed to the respective joint units of the swing leg, to realize non-slip walking of the robot.

As described above, according to an embodiment of the present invention, if slippage of the swing foot occurs when the swing foot touches the ground, restricted torques are provided to the respective joint units of the swing leg, ensuring stable walking of the robot 100 without a risk of the robot 100 falling down.

The walking robot and the control method thereof according to the embodiment of the present invention have been described above. The embodiment describes the case in which the velocity sensors 223 are provided respectively at the two feet of the robot 100 by way of example.

However, in one alternative embodiment, instead of the velocity sensors 223, acceleration sensors (not shown) may be provided at the two feet of the robot. In this case, velocity calculators (not shown) that calculate a velocity of the swing foot via integration of an acceleration sensed by the acceleration sensors may be additionally provided.

In another alternative embodiment, instead of providing the two feet of the robot 100 with the velocity sensors 223 or the acceleration sensors, the velocity of the swing foot may be calculated based on forward kinematics. In this case, a velocity calculator (not shown) to calculate the velocity of the swing foot based on forward kinematics may be additionally provided.

Alternatively, or in addition to the above-described embodiments, the robot may calculate the torque using a proportional, integral, and/or derivative controller using the calculated target angle and a target velocity obtained by taking the derivative of the target angle.

As is apparent from the above description, a walking robot and a control method thereof according to an embodiment of the present invention have the following effects.

First, stable walking of a walking robot may be realized by sensing whether or not slippage occurs upon landing of a swing foot, and by restricting a torque to be applied to a joint of a swing leg based on the sensed result.

Further, walking with low servo gain based on FSM control and torque servo control achieves a reduction in power consumption.

Furthermore, low servo gain causes low joint stiffness, resulting in a reduction in collision shock with the surrounding environment.

In addition, realization of a human-like walking robot that walks with extended knees improves likeability of the robot.

The walking robot and robot controlling method according to the above-described example embodiments may use one or more processors, which may include a microprocessor, central processing unit (CPU), digital signal processor (DSP), or application-specific integrated circuit (ASIC), as well as portions or combinations of these and other processing devices.

The controlling method according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules to perform the operations of the above-described example embodiments, or vice versa.

Although a few example embodiments of the present invention have been shown and described, it would be appreciated by those skilled in the art that changes may be made to these embodiments without departing from the principles and spirit of the invention, the scope of which is defined in the claims and their equivalents.

What is claimed is:

1. A control method of a walking robot, comprising:
generating a target angle trajectory, required for walking of the robot, with respect to each of a plurality of joint units provided at a plurality of legs according to operating states of the plurality of legs;
calculating a first torque, which tracks the target angle trajectory, with respect to each of the plurality of joint units provided at the plurality of legs;
determining whether slippage of a swing foot connected to a swing leg among the plurality of legs occurs;
calculating a final torque to be provided to at least one joint unit of the swing leg based on a velocity sensed from the swing foot if it is determined slippage of the swing foot occurs; and
providing the calculated final torque to each joint unit of the swing leg.

2. The control method according to claim 1, further comprising providing the calculated first torque to each of the plurality of joint units provided at the plurality of legs if no slippage of the swing foot occurs.

3. The control method according to claim 1, wherein calculation of the first torque includes calculating at least one of a torque in a roll-direction, a torque in a pitch-direction and a torque in a yaw-direction with respect to each of the plurality of joint units provided at the plurality of legs.

4. The control method according to claim 3, wherein the determination of whether or slippage of the swing foot occurs includes:
comparing a load sensed from the swing foot with a preset reference load;
comparing a velocity sensed from the swing foot with a preset reference velocity; and
determining a direction in which slippage of the swing foot occurs according to the comparative results.

5. The control method according to claim 4, wherein determination of the direction in which slippage of the swing foot occurs includes determining that slippage of the swing foot occurs in the pitch-direction if a Z-axis load sensed from the swing foot is less than a Z-axis reference load, an X-axis load sensed from the swing foot is less than an X-axis reference load, and an X-axis velocity sensed from the swing foot is greater than an X-axis reference velocity.

6. The control method according to claim 5, wherein calculation of the final torque includes calculating a final torque in the pitch-direction to be provided to each joint unit of the swing leg if slippage of the swing foot occurs in the pitch-direction.

7. The control method according to claim 6, wherein the final torque in the pitch-direction to be provided to each joint unit of the swing leg is obtained by multiplying a ratio of the X-axis reference velocity to the X-axis velocity sensed from the swing foot, by the torque in the pitch-direction obtained from the calculated first torque.

8. The control method according to claim 4, wherein determination of the direction in which slippage of the swing foot occurs includes determining that slippage of the swing foot occurs in the roll-direction if a Z-axis load sensed from the swing foot is less than a Z-axis reference load, a Y-axis load sensed from the swing foot is less than a Y-axis reference load, and a Y-axis velocity sensed from the swing foot is greater than a Y-axis reference velocity.

9. The control method according to claim 8, wherein calculation of the final torque includes calculating a final torque in the roll-direction to be provided to each joint unit of the swing leg if slippage of the swing foot occurs in the roll-direction.

10. The control method according to claim 9, wherein the final torque in the roll-direction to be provided to each joint unit of the swing leg is obtained by multiplying a ratio of the Y-axis reference velocity to the Y-axis velocity sensed from the swing foot, by the torque in the roll-direction obtained from the calculated first torque.

11. A walking robot comprising:
a target angle trajectory generator to generate a target angle trajectory, required for walking of the robot, with respect to each of a plurality of joint units provided at a plurality of legs according to operating states of the plurality of legs;
a torque calculator to calculate a first torque, which tracks the target angle trajectory, with respect to each of the plurality of joint units provided at the plurality of legs;
a walking state determiner to determine whether slippage of a swing foot connected to a swing leg among the plurality of legs occurs,
wherein the torque calculator calculates a final torque to be provided to at least one joint unit of the swing leg based on a velocity sensed from the swing foot if it is determined slippage of the swing foot occurs; and
a controller to provide the calculated final torque to each joint unit of the swing leg.

12. The walking robot according to claim 11, wherein the controller provides the calculated first torque to each of the plurality of joint units provided at the plurality of legs if no slippage of the swing foot occurs.

13. The walking robot according to claim 11, wherein when the torque calculator calculates the first torque, the torque calculator calculates at least one of a torque in a roll-direction, a torque in a pitch-direction and a torque in a yaw-direction with respect to each of the plurality of joint units provided at the plurality of legs.

14. The walking robot according to claim 13, wherein the walking state determiner determines the direction in which slippage of the swing foot occurs by comparing a load sensed from the swing foot with a preset reference load, and by comparing a velocity sensed from the swing foot with a preset reference velocity.

15. The walking robot according to claim 14, wherein the walking state determiner determines that slippage of the swing foot occurs in the pitch-direction if a Z-axis load sensed from the swing foot is less than a Z-axis reference load, an X-axis load sensed from the swing foot is less than an X-axis reference load, and an X-axis velocity sensed from the swing foot is greater than an X-axis reference velocity.

16. The walking robot according to claim 15, wherein the torque calculator calculates a final torque in the pitch-direction to be provided to each joint unit of the swing leg if slippage of the swing foot occurs in the pitch-direction.

17. The walking robot according to claim 16, wherein the final torque in the pitch-direction to be provided to each joint unit of the swing leg is obtained by multiplying a ratio of the X-axis reference velocity to the X-axis velocity sensed from the swing foot, by the torque in the pitch-direction obtained from the calculated first torque.

18. The walking robot according to claim 14, wherein the walking state determiner determines that slippage of the swing foot occurs in the roll-direction if a Z-axis load sensed from the swing foot is less than a Z-axis reference load, a Y-axis load sensed from the swing foot is less than a Y-axis reference load, and a Y-axis velocity sensed from the swing foot is greater than a Y-axis reference velocity.

19. The walking robot according to claim 18, wherein the torque calculator calculates a final torque in the roll-direction to be provided to each joint unit of the swing leg if slippage of the swing foot occurs in the roll-direction.

20. The walking robot according to claim 19, wherein the final torque in the roll-direction to be provided to each joint unit of the swing leg is obtained by multiplying a ratio of the Y-axis reference velocity to the Y-axis velocity sensed from the swing foot, by the torque in the roll-direction obtained from the calculated first torque.

21. The walking robot according to claim 14, further comprising a memory which stores the preset reference load and preset reference velocity values.

22. A control method of a walking robot, comprising:
generating a target angle trajectory for a first joint unit provided at a swing leg of the robot among a plurality of legs of the robot, according an operating state indicating a pose of the swing leg;
calculating a first torque, which tracks the target angle trajectory, for the first joint unit;
determining whether slippage of a swing foot connected to the swing leg occurs;
calculating and applying a second torque to the first joint unit of the swing leg based on a velocity sensed from the swing foot if it is determined slippage of the swing foot occurs, wherein the second torque is less than the first torque.

23. The control method according to claim 22, wherein the determining of whether slippage of the swing foot occurs includes sensing a velocity of the swing foot using a velocity sensor disposed on the swing foot, and sensing a load of the swing foot using a force sensor disposed on the swing foot.
